(19) United States
(12) Patent Application Publication
(10) Pub. No.: US 2008/0004091 A1
(43) Pub. Date: Jan. 3, 2008

(54) Chevron inlet for cross flow fan

(76) Inventor: Jon E. Ricketts, Ephrata, PA (US)

Correspondence Address: CNH AMERICA LLC, INTELLECTUAL PROPERTY LAW DEPARTMENT, PO BOX 1895, MS 641, NEW HOLLAND, PA, 17557, US

(21) Appl. No.: 11/477,753

(22) Filed: Jun. 29, 2006

(51) Int. Cl. A01F 12/48

(52) U.S. Cl. 460/100; 415/53.1

(57) ABSTRACT

A transverse fan assembly including a fan rotatably disposed in an air plenum for drawing air through an inlet opening and drivingly forcing air from an outlet opening defined by the air plenum, the fan having elongated fan blades angled toward a peripheral center plane of the fan such that the blades have a chevron-like configuration between opposite ends of the fan, the plenum having an inverted V-shaped inlet opening edge structure whereby the edge angles mirror the chevron angles of the adjacent fan blades thereby improving air flow uniformity and flow from the outlet of the air plenum while generating less noise.

### BACKGROUND OF THE INVENTION

The present invention relates generally to agricultural harvesters and, more particularly, to agricultural combine harvesters with a transverse fan assembly having an inlet opening structure to substantially improve output air flow across the entire length thereof and reduce noise.

Transverse fan assemblies used in agricultural combines are well known in the art. A typical agricultural combine includes a crop header apparatus which reaps planted grain stalks and then feeds the grain stalks to a threshing apparatus arranged within a body of the combine. The threshing apparatus functions to separate grain from material other than grain. As part of the threshing process, the grain is separated to fall or exit through openings in the threshing apparatus into the cleaning apparatus while material other than grain is discharged from the combine. Transverse fan assemblies provide air flow through sieves in the cleaning apparatus to separate grain from the smaller non-grain crop material sometimes called “chaff.” Grain is collected within the combine while the chaff is discharged from the combine, partially aided by air flow from the fan assembly of the cleaning apparatus.

With the increased productivity demands on modern agricultural combines, cleaning capacity has become a limiting factor to overall harvesting performance of the combine. The most readily achieved method of increasing combine efficiency is by increasing the size of the cleaning area and the sieves to spread the crop materials across a wider area and in a thinner crop mat or veil which necessitates increased air flow through the cleaning area. Conventional methods for increasing air flow provided by a transverse fan of a given width require increasing the fan tip speed, whether by increasing the fan rotational speed, increasing fan diameter, or a combination of both. Unfortunately, these methods result in increased noise from the operating fan which increases overall noise level of the combine. Moreover, space limitations often preclude increasing fan diameter as a means to increase air flow.

One method for reducing fan noise is to provide a fan having angled blades. Transverse fans having straight blades generate considerable noise as each blade passes a straight plenum cutoff edge as the blade and the edge will be instantaneously adjacent for the entire length of the fan. Transverse fans having angled blades, such as that disclosed in U.S. Pat. No. 5,599,162, reduce noise by reducing the portion of the fan blade that passes a straight cutoff edge at any instant in time. There are limitations in the angle to which a transverse fan blade may be positioned beyond which air flow in the axial direction becomes problematic and affects air flow distribution uniformity from the fan outlet.

It would be a great advantage to provide an improved cross flow fan capable of providing increased air flow to meet the needs of higher capacity combines without increasing the operating noise level of the fan thereby overcoming the above problems and disadvantages.

### SUMMARY OF THE INVENTION

Accordingly, it is an object of the present invention to provide a transverse fan assembly that includes a fan rotatably disposed in an air plenum for drawing air through an inlet opening and drivingly forcing air from an outlet opening defined by the air plenum providing a substantially even flow of air from the outlet of the air plenum along the length of the fan.

It is a further object of the present invention to provide a transverse fan having elongated fan blades that slant toward a peripheral center portion of the fan such that opposite end portions of each elongated fan blade are arranged in substantial axial alignment relative to each other, while the center portion of the respective blade is circumferentially offset relative to the end portions to provide each fan blade with a chevron-like configuration and appearance between opposite ends of the fan to facilitate a substantially constant output flow of air from the length of the fan assembly.

It is a further object of the present invention to provide a transverse fan assembly plenum having an inverted V-shaped inlet opening edge structure whereby the edge angles are oppositely oriented to the chevron angles of the adjacent fan blades to improve the output flow of air from the length of the fan assembly.

It is a further object of the present invention to provide a transverse fan assembly having an inverted V-shaped inlet opening edge structure oppositely oriented from the chevron-like configuration of the fan blades to reduce noise caused by the interaction of the fan blades and the inlet opening edge.

It is a further object of the present invention to provide a transverse fan assembly using fan blades arranged in a chevron-like configuration interacting with an inverted V-shaped plenum edge structure that simultaneously improves air flow while reducing noise generated by the fan assembly.

It is a still further object of the present invention to provide a transverse fan assembly having a cooperating fan blade orientation and plenum inlet opening configuration capable of providing increased air flow to the cleaning assembly of an agricultural combine.

It is a still further object of the present invention to provide a transverse fan assembly having a cooperating fan blade orientation and plenum inlet opening configuration capable of reducing the noise level of the fan used in the cleaning assembly of an agricultural combine.

It is a still further object of the present invention to provide a transverse fan assembly that is durable in construction, inexpensive of manufacture, carefree of maintenance, easily assembled, and simple and effective to use.

These and other objects are achieved by providing a transverse fan assembly that includes a fan rotatably disposed in an air plenum for drawing air through an inlet opening and drivingly forcing air from an outlet opening defined by the air plenum, the fan having elongated fan blades that slant toward a peripheral center portion of the fan such that opposite end portions of each elongated fan blade are arranged in substantial axial alignment relative to each other, while the center portion of the respective blade is circumferentially offset relative to the end portions to provide each fan blade with a chevron-like configuration between opposite ends of the fan, the plenum having an inverted V-shaped inlet opening edge structure whereby the angle formed by the inlet edge and the chevron-like blades is bisected by a line parallel to the fan axis of rotation thereby providing a substantially even flow of air from the outlet of the air plenum along the length of the fan that is greater than a conventional fan while generating less noise.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 a perspective view, partially broken away, of a combine harvester in which the present invention is useful;

FIG. 2 is a cross-sectional view showing a threshing apparatus and cleaning system of the combine harvester;

FIG. 3 is an enlarged cross-sectional view of the cleaning system of the combine harvester;

FIG. 4 is a perspective view of a fan rotor assembly according to the present invention;

FIG. 5 is a cross-sectional view taken along line 5-5 of FIG. 3 showing the preferred embodiment of the present invention; and

FIG. 6 is an enlarged side elevation view of the fan taken along line 6-6 of FIG. 5.

### DESCRIPTION OF THE PREFERRED EMBODIMENT(S)

The terms “grain,” “straw,” “chaff” and “tailings” are used principally throughout this specification for convenience and it is to be understood that these terms are not intended to be limiting. Thus “grain” refers to that part of the crop material which is threshed and separated from the discardable part of the crop material, which is referred to as “straw.” Incompletely threshed crop material is referred to as “tailings.” The smallest pieces of tailings are referred to as “chaff.” Also, any reference herein to the terms “left” or “right,” “forward” or “rearward,” or “top” or “bottom” are used as a matter of mere convenience, and are determined by standing at the rear of the machine facing in its normal direction of travel; use of these terms should not be construed as limiting. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail.

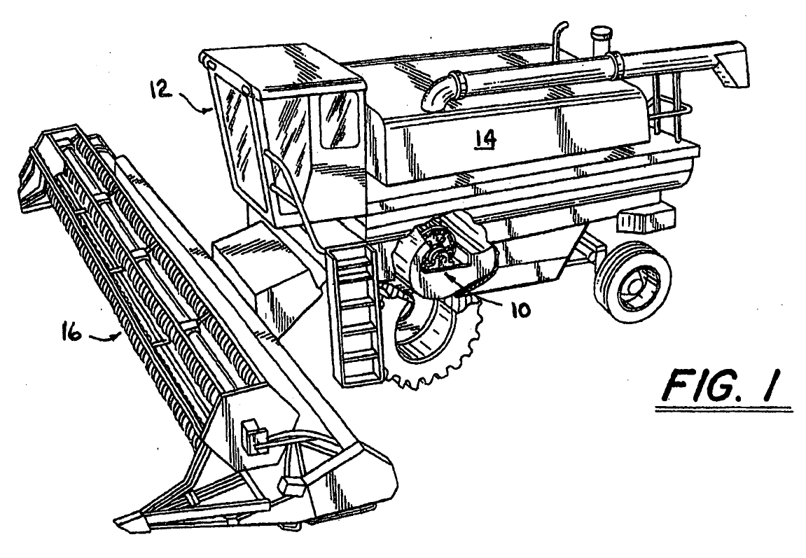

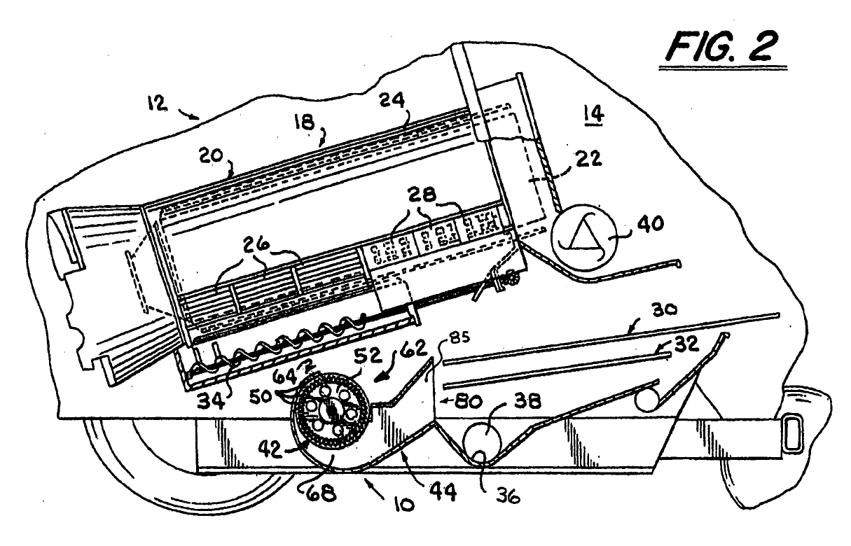

Referring now to the drawings, wherein like reference numerals indicate like parts throughout the several views. FIGS. 1 and 2 illustrate a fan assembly 10 according to the present invention arranged in operable combination with a conventional self-propelled agricultural combine harvester 12 of the axial-flow type, wherein crop material is threshed and separated while it is advanced by and along a longitudinally arranged rotor. It should be appreciated, however, that the principles and teachings of the present invention equally apply to fan assemblies that are used in conventional and dual rotor threshing systems used in other agricultural combines or in other applications.

The self-propelled combine harvester is operatively powered by an engine (not shown) suitably housed within a body 14 of the combine harvester to provide driving power. The transfer of rotation and power from the engine to various driven components of the combine is of a conventional nature and could include fixed or variable belt or chain drives which are not shown for purposes of clarity.

At its front end, combine harvester 12 is provided with a conventional crop harvesting header 16. The choice of header, of course, does not limit or relate to the present invention. The crop harvesting header 16 cuts and directs crop material into a conventional threshing apparatus 18 (FIG. 2). As is well known in the art, the threshing apparatus includes a rotor assembly 20, including a relatively large diameter rotor 22 that is mounted within a threshing cage 24. Disposed about the cage 24 is a simple system of concaves 26 and separating grates 28 which, through the action of the rotor 22 and centrifugal force, act to separate grain from the straw and deliver such material to a pair of vertically spaced apart cleaning sieves 30 and 32. In the embodiment shown, auger 34 moves grain to the cleaning sieves 30 and 32 defining part of a cleaning area on the combine. One such example is described in U.S. Pat. No. 5,599,162, herein incorporated in its entirety by reference.

The sieves 30 and 32 are mounted for oscillation to separate the grain from the tailings. The oscillation of the sieves 30 and 32 arranges the tailings received from the threshing apparatus 18 in a relatively large crop mat or veil extending across substantially the entire sieve. The heavier grain falls through the sieves 30 and 32 to a clean grain collector 36. An auger 38 directs the grain from the collector 36 into a hopper or grain bin (not shown) often housed generally directly behind the cab 12 within combine harvester body 14. Material which is too large to pass through the concaves 26 and grates 28 (chaff) is propelled rearwardly through the rotor assembly 20. A conventional beater 40 acts upon the chaff discharged from the rotor assembly 20. Beater 40 propels straw and chaff from the rear of the rotor assembly 20 and throws it back for broad discharge from the rear end of the combine.

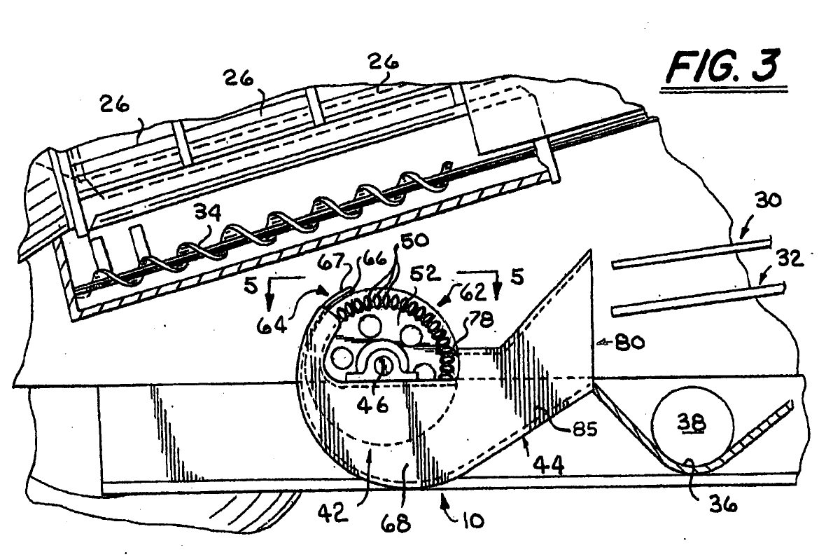

Referring now to FIG. 3, fan assembly 10, constructed in accordance with the present invention, is arranged in combination with the cleaning sieves 30, 32. The fan assembly 10 comprises an elongated transverse or cross flow fan 42 and an air plenum 44. Fan 42 extends transversely across substantially the entire width of the combine harvester 12. More specifically, fan 42 is transversely mounted on the combine harvester 12 beneath the threshing apparatus 18 and preferably forward of the cleaning sieves 30, 32.

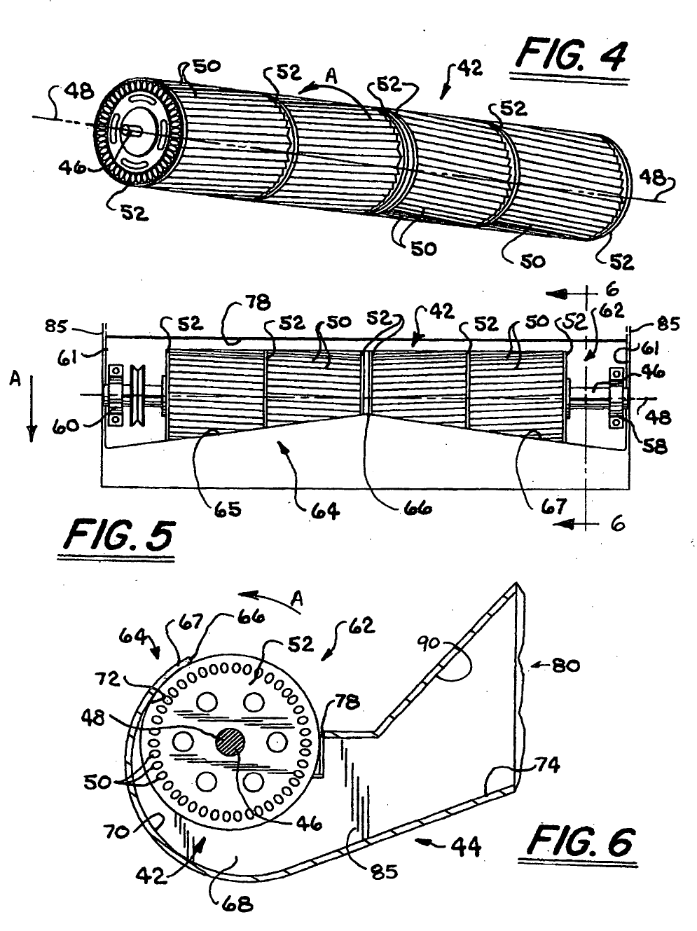

As shown in FIGS. 3 and 4, fan 42 includes a central and preferably elongated axle 46 defining an elongated axis of a rotation 48 for the fan assembly 10, a plurality of closely spaced fan blades 50 extending axially in a circumferential array or pattern about the axis of rotation 48 to define an open center for the fan 42, and a plurality of axially spaced and aligned fan blade mounting disks 52. The mounting disks 52 are of substantially uniform diameter. Each fan blade mounting disk 52 is connected to and extends radially outward from the axle 46 for driving the fan blades 50, thereby establishing an air flow through the air plenum 44. Air enters the plenum through air inlet 62 and is discharged through air outlet 80. While mounting disk 52 is shown as having a generally round geometric configuration, it could take any suitable shape, such as, for example, spoke-shaped, star-shaped, and the like.

The fan blades 50 have a generally curved cross-sectional configuration and are arranged in closely spaced relation relative to each other. Each fan blade 50 preferably has a forwardly curved cross sectional configuration. A pair of fan blade mounting disks 52 are arranged toward opposite ends of the fan 42. Since the length of the transverse fan 42 is functionally unlimited, other disks 52 may be provided along the length of the fan 42 to counteract centrifugal forces acting on the blades 50 during operation of the fan assembly 10. In a most preferred form the invention, each fan blade 50 is formed from a material such as sheet metal and is connected to the fan blade mounting disks 52. One or more disks 52 may be arranged along the length of the fan 42.

Referring now to FIGS. 4 and 5, opposite ends of the fan blades 50 are arranged in general axial alignment relative to each other. The center portion of each fan blade 50 is, however, offset in circumferential relation relative to the opposite end thereof such that the fan blade 50 slants or tapers toward a peripheral center portion of the fan whereby each fan blade 50 has a chevron-like configuration between opposite ends thereof. The chevron “points” in the direction of fan rotation when the fan is operating, shown as arrow “A” in FIGS. 4 and 5. The resultant flow of air off the blades 50 is directed outwardly toward the fan ends in a manner improving fan performance by lessening end air effects and thereby providing a generally uniform air distribution across the width of fan 42. Slanting of the fan blades 52 furthermore has proven to reduce operating noise (sound) levels of the fan 42. Accordingly, higher fan speeds can be used to increase the output flow of air from the fan 42 without concern over increasing environmental noise pollution or noise levels can be reduced when the fan speed remains unchanged. The degree of slanting, or angle, of the fan blades 50 that may be used for noise reduction is not without limits. As the blade angle is increased from zero with respect to the axis of rotation 48, zero angle being an axially straight blade, air flow outwardly from air outlet 80 is initially increased, air flow uniformity is improved, and noise is reduced. As the fan blade angle is increased further, air flow in the axial direction of the fan increases, lessening the air flowing tangentially from the fan blades which tends to negatively affect air flow rate and uniformity, and to increase noise. Fans in which fan blades 50 are arranged in a cylindrical pattern wherein the blades are in substantially parallel axial alignment with the axis of rotation 48, that is there is no angling of the fan blades 50, are also contemplated by the invention.

As shown in FIG. 5, fan 42 is supported at opposite ends by axle 46 which is rotatably mounted in bearing blocks 58 and 60 secured at opposite open ends of the air plenum 44. The air plenum 44 extends parallel to and along substantially the entire length of the fan 42. The air plenum 44 is preferably fabricated from an air impervious material such as steel or the like and defines an elongated air inlet opening 62 and an elongated air outlet opening 66 for directing air discharged therefrom toward the cleaning sieves 30 and 32. The air plenum 44 further defines an internal chamber 68, wherein the fan 42 is rotatably mounted to drive air between the air inlet and air outlet opening 62 and 80 respectively.

Referring to FIGS. 5 and 6, the chamber 68 defined by the air plenum 44 has a cross-sectional scroll-like configuration and includes an upper chamber wall 90, a lower chamber wall 70, and opposing side walls 85 interconnecting the two to form chamber 68. Upper chamber wall 90 spans the width of air plenum 44, bounded forwardly by baffle edge 78 and extending rearwardly therefrom defining the upper portion of chamber 68 to its readwardmost edge proximal air outlet opening 80. Lower chamber wall 70 similarly spans the width of air plenum 44 forming a continuous inner chamber wall from cutoff edge 64 positioned proximate the fan periphery to the readwardmost edge proximal air outlet opening 80 and below the rearward edge of upper chamber wall 90. Lower chamber wall 70 includes an upstream curvilinear face 72 and a downstream curvilinear face 74. At the inlet opening 62, the upstream curvilinear face 72 is disposed closely adjacent the periphery of fan 42, including the projection of first and second cutoff edges 65, 67 into the inlet opening 62. Chamber wall 70 increases in distance from the periphery of fan 42 as it leads to the downstream face 74. The downstream face 74 of the chamber wall 70 extends rearwardly and upwardly toward the sieves 30, 32 to its rearwardmost edge at air outlet opening 80 for directing cleaning air exhausted from the fan 42. This configuration of the air plenum chamber 68 is such that the air flow generated by the rotation of the fan 42 pushes upon itself in the area wherein the chamber wall 70 is arranged proximate to the periphery of the fan, thus adding pressure to the air flow generated by the fan 42 and directed upwardly toward the sieves 30, 32. Advantageously, the air plenum 44 wraps about and extends across the front of the fan 42 to protect the fan blades 50 from being damaged by rocks and other debris that are present in the field as the combine moves thereover.

The air inlet opening 62 defined by the air plenum 44 extends across a top side of the fan 42 and opens to both forward and rearward portions of the fan 42, bounded forwardly by cutoff edge 64 and rearwardly by baffle edge 78. Air inlet opening 62 is further defined by opposing plenum side edges 61, baffle edge 78, and cutoff edge 64. Side edges 61 and baffle edge 78 are substantially straight with the side edges oriented substantially perpendicular to axis of rotation 48 and the baffle edge substantially parallel to the axis of rotation 48. The cutoff edge 64 includes first and second cutoff edges 65, 67, intersecting at and separated by an apex 66. Apex 66 is centrally positioned alongside the length of fan 42. The cutoff edges 65, 67 are angled with respect to axis of rotation 48, being substantially symmetrically angled about apex 66 and substantially spanning the width of the air inlet opening 62 to form an inverted V-like structure that extends into inlet opening 62, continuing in the direction of upstream curvilinear face 72. The angles of the first and second cutoff edges 65, 67 are similar, but reversed from the angles of the adjacent fan blades 50. Apex 66 of the V-like structure formed by first and second cutoff edges 65, 67 points in the opposite direction as the chevron pattern of the fan blades 50 and is substantially aligned with the longitudinal center of fan 42. As a result, the angles formed between cutoff edges 65, 67 and the adjacent fan blades 50 are generally bisected by a line parallel to axis of rotation 48. The effect is a doubling of the intersecting angle formed between a fan blade 50 and the cutoff edge 65 or 67 as the fan rotates. By providing an angled cutoff edge, the intersecting angle between the fan blades 50 and the plenum cutoff edge 64 can be increased beyond the known limitations of angled fan blades in cross-flow fans. These further increases in intersecting angle between fan blades and the plenum cutoff edge reduce the portion of the blade/cutoff edge interacting at a discreet point in time compared to a substantially straight cutoff edge interacting with an angled fan blade without the limitations and, consequently, the noise caused by the interaction.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions.

Having thus described the invention, what is claimed is:

1. A transverse fan assembly comprising:
a plenum defining an inlet opening and an outlet opening, said inlet opening having at least one edge;
a transverse fan disposed within said plenum, said transverse fan directionally rotatable about an axis of rotation for drawing air in through said inlet opening and discharging air outwardly through said outlet opening; and
said at least one inlet opening edge having a first cutoff edge and a second cutoff edge, wherein said first and second cutoff edges form a V-shape with respect to said axis of rotation.

2. The transverse fan assembly of claim 1, wherein said V-shape is inverted with respect to said axis of rotation.

3. The transverse fan assembly of claim 2, wherein said first and second cutoff edges meet at an apex, wherein said apex points in a direction opposite said direction of the rotation of said fan.

4. The transverse fan assembly of claim 2, wherein said fan has blades oriented substantially parallel to said axis of rotation.

5. The transverse fan assembly of claim 2, wherein said fan has blades oriented in a chevron-like configuration.

6. The transverse fan assembly according to claim 5, wherein an angle formed between said first cutoff edge and an adjacent one of said blades is substantially bisected by a line parallel to said axis of rotation.

7. The transverse fan assembly of claim 6, wherein said first and second cutoff edges meet at an apex, said apex pointing in a direction opposite said direction of the rotation.

8. The transverse fan assembly of claim 7 wherein said fan has a length along said axis of rotation and said apex is substantially centered along said length.

9. The transverse fan assembly of claim 2, wherein said fan has blades arranged in a substantially axially cylindrical pattern about said axis of rotation, that, in rotation, generate a periphery, said plenum has an inner chamber wall having an upper curvilinear portion adjacent to said inlet opening and a downstream curvilinear portion, said inner chamber wall increasing in distance from said periphery as it leads to said downstream curvilinear portion, and said at least one inlet opening edge is a proximal edge of said upstream curvilinear portion.

10. The transverse fan assembly of claim 9, wherein said at least one inlet opening edge is adjacent said periphery of said fan.

11. The transverse fan assembly of claim 8, wherein said transverse fan assembly is disposed within an agricultural combine having a power source for rotating said fan to discharge air outwardly through said outlet opening, a threshing apparatus, and cleaning sieves arranged in crop receiving relation relative to said threshing apparatus such that air discharge from said transverse fan assembly is directed through said cleaning sieves.

12. A plenum for receiving a transverse fan comprising:
an upper chamber wall;
a lower chamber wall, which, along with said upper chamber wall, defines an inlet opening and an outlet opening, said lower chamber wall having an upstream curvilinear portion adjacent to said inlet opening and a downstream curvilinear portion; and
a cutoff edge extending from said upstream curvilinear portion, said cutoff edge having a first angled edge and a second angled edge forming an inverted V-shape.

13. The plenum of claim 12, wherein said plenum further comprises opposing side walls extending substantially perpendicularly between said upper and lower chamber walls, each having a side edge, said upper chamber wall having a baffle edge, whereby said inlet opening is defined by said opposing side wall edges, said baffle edge, and said cutoff edge.

14. The plenum of claim 13, wherein a transverse fan with an axis of rotation is disposed within said plenum, said fan further having blades arranged in a substantially axially cylindrical pattern about said axis of rotation, that, in rotation, generate a periphery such that said cutoff edge is adjacent said periphery.

15. The plenum of claim 14, wherein said blades are oriented to form a chevron-like configuration.

16. The plenum of claim 15, wherein said first and second angled edges meet at an apex, said fan has a length along said axis of rotation, and said apex is substantially centrally disposed along the length of said transverse fan.

17. The plenum of claim 16, where said plenum is disposed within an agricultural combine having a power source for rotating said fan to discharge air outwardly through said outlet opening, a threshing apparatus, and cleaning sieves arranged in crop receiving relation relative to said threshing apparatus such that air discharge from said transverse fan assembly is directed through said cleaning sieves.

18. An inlet edge for a transverse fan in a plenum, said plenum having an air inlet opening formed by a plurality of adjacent edges, one of said plurality of edges being said inlet edge and comprising first and second cutoff edges meeting at an apex, said first and second cutoff edges angularly extending from said apex toward respective adjacent edges of said inlet opening.

19. The inlet edge of claim 18, wherein said plenum has two opposing side walls adjacent respective said opposing adjacent edges and extending therefrom, said plenum further including a transverse fan disposed therein rotatable about an axis of rotation, said axis of rotation being substantially perpendicular to said two opposing side walls.

20. The inlet edge of claim 19, wherein said transverse fan has a direction of rotation and said apex point is aimed opposite said direction of rotation.
